(19) United States
(12) Patent Application Publication
(10) Pub. No.: US 2025/0048091 A1
(43) Pub. Date: Feb. 6, 2025

(54) SECURING COMMUNICATIONS USING SECURITY KEYS BASED AT LEAST IN PART ON PHYSICAL LAYER PARAMETERS

(71) Applicant: QUALCOMM Incorporated, San Diego, CA (US)

(72) Inventors: Ahmed ELSHAFIE, San Diego, CA (US); Hung Dinh LY, San Diego, CA (US); Alexandros MANOLAKOS, Athens (GR)

(21) Appl. No.: 18/717,128

(22) PCT Filed: Feb. 13, 2023
(86) PCT No.: PCT/US2023/062504

§ 371 Date: Jun. 6, 2024

(30) Foreign Application Priority Data
Feb. 17, 2022 (GR) 20220100145

(51) Int. Cl. H04W 12/043; H04L 5/14; H04W 12/041; H04W 72/11; H04W 72/1268

(52) U.S. Cl. CPC H04W 12/043; H04L 5/1469; H04W 12/041; H04W 72/11; H04W 72/1268

(57) ABSTRACT

Various aspects of the present disclosure generally relate to wireless communication. In some aspects, a network node may receive at least one communication of a plurality of communications associated with at least one physical layer channel, wherein a first set of the plurality of communications includes the at least one communication and is secured by a first security key, and a second set of the plurality of communications is secured by a second security key. The network node may decrypt the at least one communication based at least in part on the first security key, wherein the first security key is based at least in part on a first set of physical layer parameter values and the second security key is based at least in part on a second set of physical layer parameter values. Numerous other aspects are described.

### CROSS-REFERENCE TO RELATED APPLICATION

This patent application claims priority to Greek patent application No. 20220100145, filed on Feb. 17, 2022, entitled “SECURING COMMUNICATIONS USING SECURITY KEYS BASED AT LEAST IN PART ON PHYSICAL LAYER PARAMETERS.” The disclosure of the prior application is considered part of and is incorporated by reference in this patent application.

### FIELD OF THE DISCLOSURE

Aspects of the present disclosure generally relate to wireless communication and to techniques and apparatuses for securing communications using security keys based at least in part on physical layer parameters.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed at a first network node. The method may include receiving at least one communication of a plurality of communications associated with at least one physical layer channel, wherein a first set of the plurality of communications includes the at least one communication and is secured by a first security key of a plurality of security keys, and wherein a second set of the plurality of communications is secured by a second security key of the plurality of security keys. The method may include decrypting the at least one communication based at least in part on the first security key, wherein the first security key is based at least in part on a first set of physical layer parameter values, and wherein the second security key is based at least in part on a second set of physical layer parameter values.

Some aspects described herein relate to a method of wireless communication performed at a second network node. The method may include transmitting a first communication of a plurality of communications associated with at least one physical layer channel, wherein a first set of the plurality of communications includes the at least one communication and is secured by a first security key of a plurality of security keys. The method may include transmitting a second communication of the plurality of communications, wherein a second set of the plurality of communications is secured by a second security key of the plurality of security keys.

Some aspects described herein relate to a first network node for wireless communication. The first network node may include a memory and one or more processors coupled to the memory. The one or more processors may be configured to receive at least one communication of a plurality of communications associated with at least one physical layer channel, wherein a first set of the plurality of communications includes the at least one communication and is secured by a first security key of a plurality of security keys, and wherein a second set of the plurality of communications is secured by a second security key of the plurality of security keys. The one or more processors may be configured to decrypt the at least one communication based at least in part on the first security key, wherein the first security key is based at least in part on a first set of physical layer parameter values, and wherein the second security key is based at least in part on a second set of physical layer parameter values.

Some aspects described herein relate to a first network node for wireless communication. The first network node may include a memory and one or more processors coupled to the memory. The one or more processors may be configured to transmit a first communication of a plurality of communications associated with at least one physical layer channel, wherein a first set of the plurality of communications includes the at least one communication and is secured by a first security key of a plurality of security keys. The one or more processors may be configured to transmit a second communication of the plurality of communications, wherein a second set of the plurality of communications is secured by a second security key of the plurality of security keys.

Some aspects described herein relate to a non-transitory computer-readable medium that stores a set of instructions for wireless communication by a first network node. The set of instructions, when executed by one or more processors of the first network node, may cause the first network node to receive at least one communication of a plurality of communications associated with at least one physical layer channel, wherein a first set of the plurality of communications includes the at least one communication and is secured by a first security key of a plurality of security keys, and wherein a second set of the plurality of communications is secured by a second security key of the plurality of security keys. The set of instructions, when executed by one or more processors of the first network node, may cause the first network node to decrypt the at least one communication based at least in part on the first security key, wherein the first security key is based at least in part on a first set of physical layer parameter values, and wherein the second security key is based at least in part on a second set of physical layer parameter values.

Some aspects described herein relate to a non-transitory computer-readable medium that stores a set of instructions for wireless communication by a first network node. The set of instructions, when executed by one or more processors of the first network node, may cause the first network node to transmit a first communication of a plurality of communications associated with at least one physical layer channel, wherein a first set of the plurality of communications includes the at least one communication and is secured by a first security key of a plurality of security keys. The set of instructions, when executed by one or more processors of the first network node, may cause the first network node to transmit a second communication of the plurality of communications, wherein a second set of the plurality of communications is secured by a second security key of the plurality of security keys.

Some aspects described herein relate to an apparatus for wireless communication. The apparatus may include means for receiving at least one communication of a plurality of communications associated with at least one physical layer channel, wherein a first set of the plurality of communications includes the at least one communication and is secured by a first security key of a plurality of security keys, and wherein a second set of the plurality of communications is secured by a second security key of the plurality of security keys. The apparatus may include means for decrypting the at least one communication based at least in part on the first security key, wherein the first security key is based at least in part on a first set of physical layer parameter values, and wherein the second security key is based at least in part on a second set of physical layer parameter values.

Some aspects described herein relate to an apparatus for wireless communication. The apparatus may include means for transmitting a first communication of a plurality of communications associated with at least one physical layer channel, wherein a first set of the plurality of communications includes the at least one communication and is secured by a first security key of a plurality of security keys. The apparatus may include means for transmitting a second communication of the plurality of communications, wherein a second set of the plurality of communications is secured by a second security key of the plurality of security keys.

Aspects generally include a method, apparatus, system, computer program product, non-transitory computer-readable medium, user equipment, base station, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of network communications, in accordance with the present disclosure.

FIG. 4 is a diagram illustrating an example associated with securing communications using security keys based at least in part on physical layer parameters, in accordance with the present disclosure.

FIGS. 5 and 6 are diagrams illustrating example processes associated with securing communications using security keys based at least in part on physical layer parameters, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

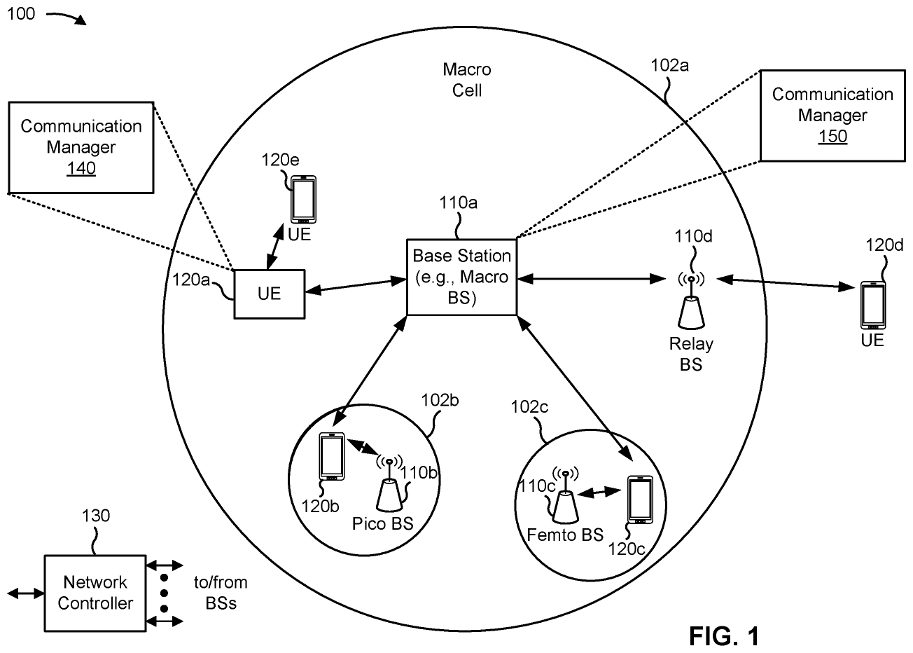

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120c), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link. For example, in some aspects, the wireless network 100 may be, include, or be included in a wireless backhaul network, sometimes referred to as an integrated access and backhaul (IAB) network. In an IAB network, at least one base station (e.g., base station 110) may be an anchor base station that communicates with a core network via a wired backhaul link, such as a fiber connection. An anchor base station may also be referred to as an IAB donor (or IAB-donor), a central entity, a central unit, and/or the like. An IAB network may include one or more non-anchor base stations, sometimes referred to as relay base stations or IAB nodes (or IAB-nodes). The non-anchor base station may communicate directly with or indirectly with (e.g., via one or more non-anchor base stations) the anchor base station via one or more backhaul links to form a backhaul path to the core network for carrying backhaul traffic. Backhaul links may be wireless links. Anchor base station(s) and/or non-anchor base station(s) may communicate with one or more UEs (e.g., UE 120) via access links, which may be wireless links for carrying access traffic.

In some aspects, a radio access network that includes an IAB network may utilize millimeter wave technology and/or directional communications (e.g., beamforming, precoding and/or the like) for communications between base stations and/or UEs (e.g., between two base stations, between two UEs, and/or between a base station and a UE). For example, wireless backhaul links between base stations may use millimeter waves to carry information and/or may be directed toward a target base station using beamforming, precoding, and/or the like. Similarly, wireless access links between a UE and a base station may use millimeter waves and/or may be directed toward a target wireless node (e.g., a UE and/or a base station). In this way, inter-link interference may be reduced.

An IAB network may include an IAB donor that connects to a core network via a wired connection (e.g., a wireline backhaul). For example, an Ng interface of an IAB donor may terminate at a core network. Additionally, or alternatively, an IAB donor may connect to one or more devices of the core network that provide a core access and mobility management function (AMF). In some aspects, an IAB donor may include a base station 110, such as an anchor base station. An IAB donor may include a central unit (CU), which may perform access node controller (ANC) functions and/or AMF functions. The CU may configure a distributed unit (DU) of the IAB donor and/or may configure one or more IAB nodes (e.g., a mobile termination (MT) function and/or a DU function of an IAB node) that connect to the core network via the IAB donor. Thus, a CU of an IAB donor may control and/or configure the entire IAB network (or a portion thereof) that connects to the core network via the IAB donor, such as by using control messages and/or configuration messages (e.g., a radio resource control (RRC) configuration message or an F1 application protocol (FIAP) message).

The MT functions of an IAB node (e.g., a child node) may be controlled and/or scheduled by another IAB node (e.g., a parent node of the child node) and/or by an IAB donor. The DU functions of an IAB node (e.g., a parent node) may control and/or schedule other IAB nodes (e.g., child nodes of the parent node) and/or UEs 120. Thus, a DU may be referred to as a scheduling node or a scheduling component, and an MT may be referred to as a scheduled node or a scheduled component. In some aspects, an IAB donor may include DU functions and not MT functions. That is, an IAB donor may configure, control, and/or schedule communications of IAB nodes and/or UEs 120. A UE 120 may include only MT functions, and not DU functions. That is, communications of a UE 120 may be controlled and/or scheduled by an IAB donor and/or an IAB node (e.g., a parent node of the UE 120).

When a first node controls and/or schedules communications for a second node (e.g., when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor or an IAB node, and a child node may be an IAB node or a UE 120. Communications of an MT function of a child node may be controlled and/or scheduled by a parent node of the child node.

A link between a UE 120 and an IAB donor, or between a UE 120 and an IAB node, may be referred to as an access link. An access link may be a wireless access link that provides a UE 120 with radio access to a core network via an IAB donor, and optionally via one or more IAB nodes. Thus, the network 100 may be referred to as a multi-hop network or a wireless multi-hop network.

A link between an IAB donor and an IAB node or between two IAB nodes may be referred to as a backhaul link. A backhaul link may be a wireless backhaul link that provides an IAB node with radio access to a core network via an IAB donor, and optionally via one or more other IAB nodes. In an IAB network, network resources for wireless communications (e.g., time resources, frequency resources, and/or spatial resources) may be shared between access links and backhaul links. In some aspects, a backhaul link may be a primary backhaul link or a secondary backhaul link (e.g., a backup backhaul link). In some aspects, a secondary backhaul link may be used if a primary backhaul link fails, becomes congested, and/or becomes overloaded, among other examples.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrow band IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FRI (410 MHz-7.125 GHz) and FR2 (24.25 GHz-52.6 GHz). It should be understood that although a portion of FR1 is greater than 6 GHZ, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz). FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2. FR4. FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described herein, a network node, which may be referred to as a “node.” a “network node.” or a “wireless node.” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some aspects, the first network node may include a communication manager 140 or a communication manager 150. As described in more detail elsewhere herein, the communication manager 140 or 150 may receive at least one communication of a plurality of communications associated with at least one physical layer channel, wherein a first set of the plurality of communications includes the at least one communication and is secured by a first security key of a plurality of security keys, and a second set of the plurality of communications is secured by a second security key of the plurality of security keys; and decrypt the at least one communication based at least in part on the first security key, wherein the first security key is based at least in part on a first set of physical layer parameter values, and the second security key is based at least in part on a second set of physical layer parameter values.

As described in more detail elsewhere herein, the communication manager 140 or 150 may transmit a first communication of a plurality of communications associated with at least one physical layer channel, wherein a first set of the plurality of communications includes the at least one communication and is secured by a first security key of a plurality of security keys; and transmit a second communication of the plurality of communications, wherein a second set of the plurality of communications is secured by a second security key of the plurality of security keys. Additionally, or alternatively, the communication manager 140 or 150 may perform one or more other operations described herein.

As indicated above, FIG. 1 is provided as an example. Other examples may differ from what is described with regard to FIG. 1.

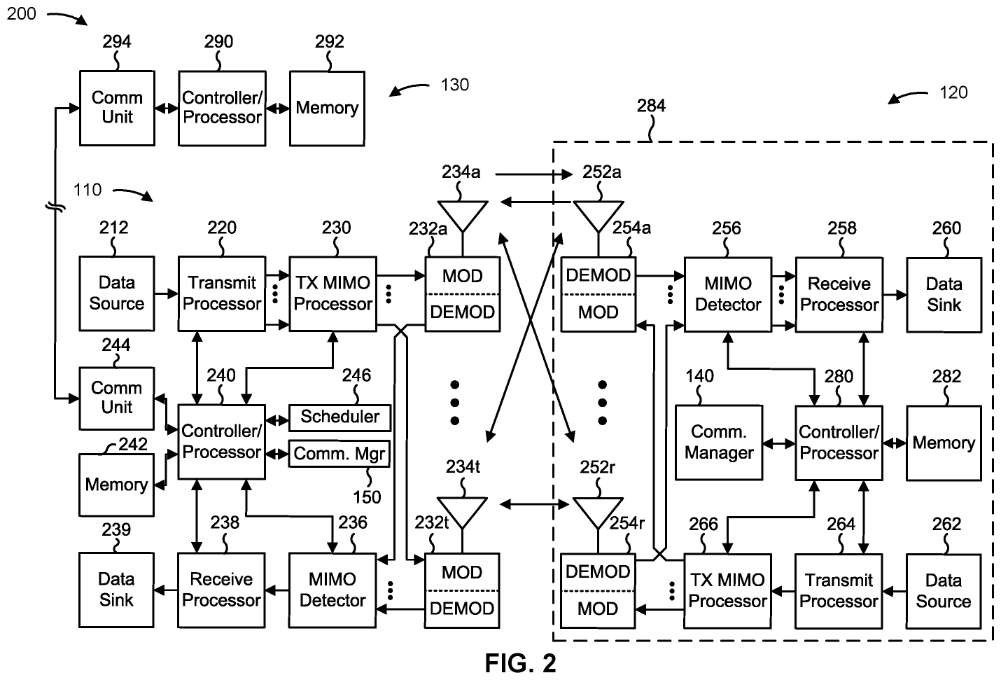

FIG. 2 is a diagram illustrating an example 200 of a base station 110 in communication with a UE 120 in a wireless network 100, in accordance with the present disclosure. The base station 110 may be equipped with a set of antennas 234a through 234t, such as T′antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

In some aspects, the term “base station” (e.g., the base station 110), “network entity.” or “network node” may refer to an aggregated base station, a disaggregated base station, an IAB node, a relay node, and/or one or more components thereof. For example, in some aspects, “base station,” “network entity,” or “network node” may refer to a CU, a DU, a radio unit (RU), a Near-Real Time (Near-RT) RAN Intelligent Controller (RIC), or a Non-Real Time (Non-RT) RIC, or a combination thereof. In some aspects, the term “base station,” “network entity,” or “network node” may refer to one device configured to perform one or more functions, such as those described herein in connection with the base station 110. In some aspects, the term “base station,” “network entity,” or “network node” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network entity,” or “network node” may refer to any one or more of those different devices. In some aspects, the term “base station,” “network entity,” or “network node” may refer to one or more virtual base stations and/or one or more virtual base station functions. For example, in some aspects, two or more base station functions may be instantiated on a single device. In some aspects, the term “base station,” “network entity,” or “network node” may refer to one of the base station functions and not another. In this way, a single device may include more than one base station.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qel-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

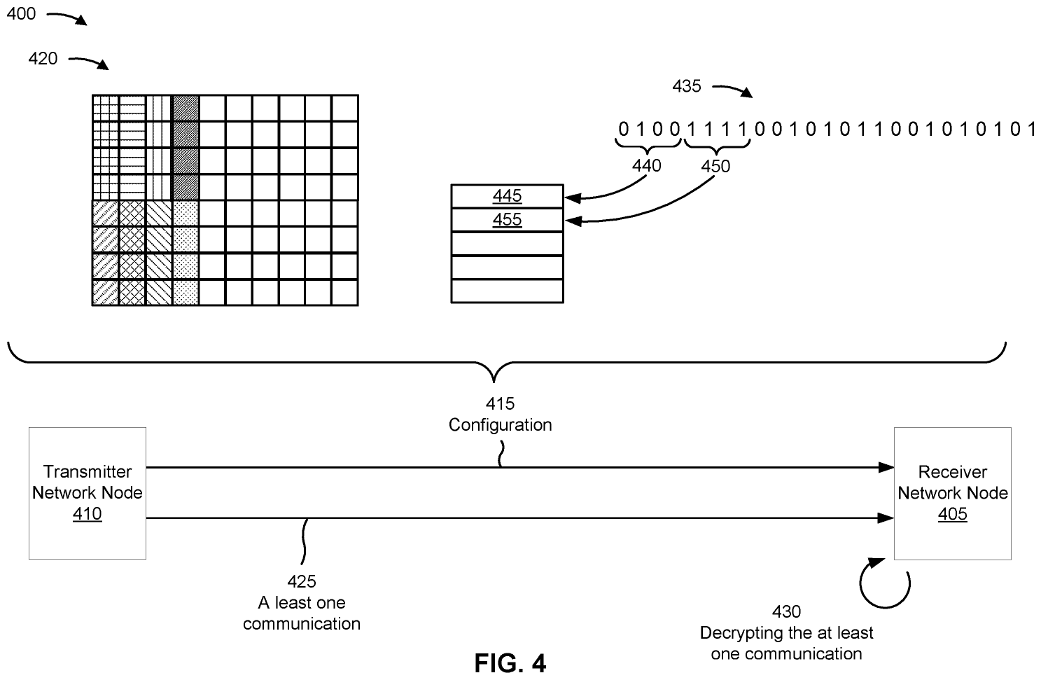

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-7).

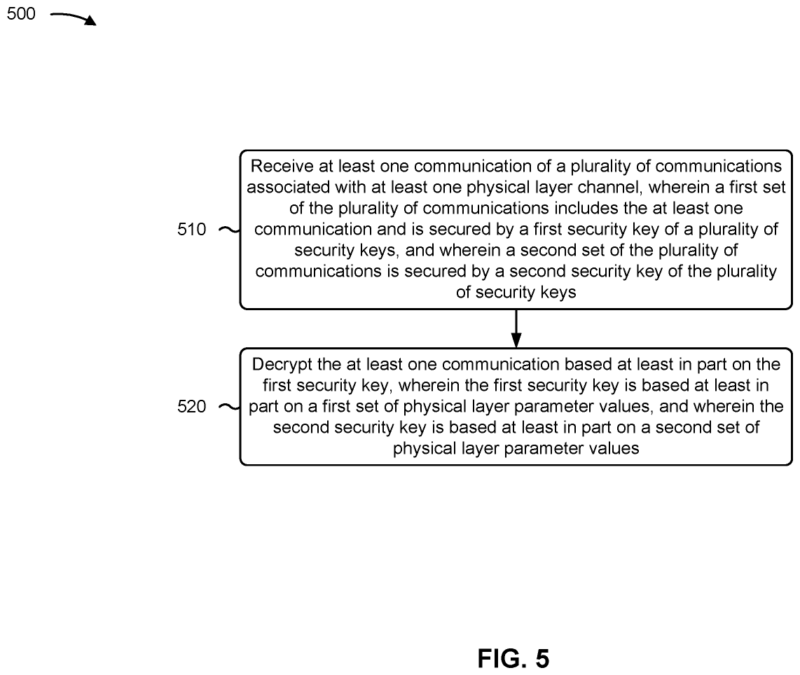

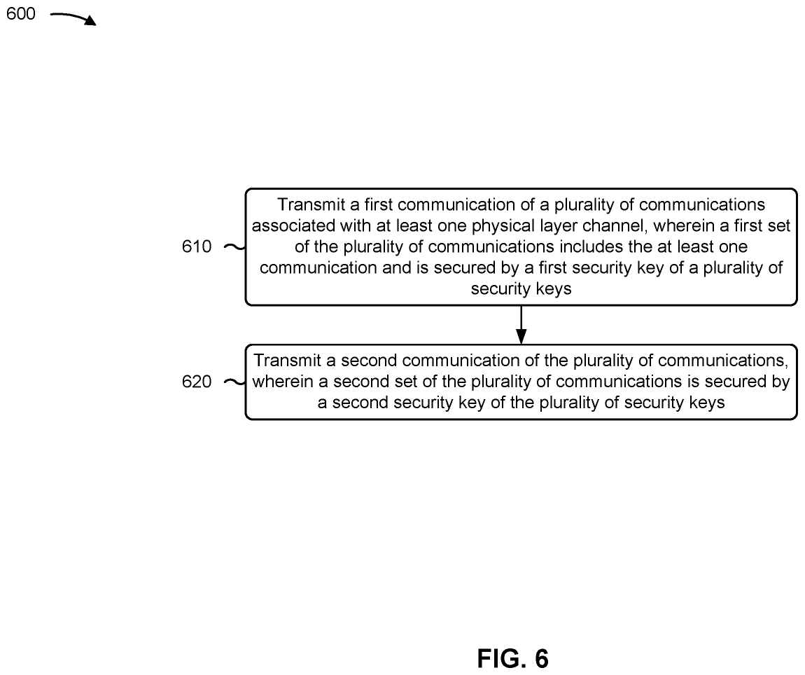

The controller/processor 240 of the base station 110, the controller/processor 280 of the UE 120, and/or any other component(s) of FIG. 2 may perform one or more techniques associated with securing communications using security keys based at least in part on physical layer parameters, as described in more detail elsewhere herein. In some aspects, the network node described herein is the base station 110, is included in the base station 110, or includes one or more components of the base station 110 shown in FIG. 2. In some aspects, the network node described herein is the UE 120, is included in the UE 120, or includes one or more components of the UE 120 shown in FIG. 2. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the first network node includes means for receiving at least one communication of a plurality of communications associated with at least one physical layer channel, wherein a first set of the plurality of communications includes the at least one communication and is secured by a first security key of a plurality of security keys, and a second set of the plurality of communications is secured by a second security key of the plurality of security keys (e.g., using antenna 234 or 252, modem 232 or 254, MIMO detector 236 or 256, receive processor 238 or 258, controller/processor 240 or 280, memory 242 or 282, or the like); and/or means for decrypting the at least one communication based at least in part on the first security key, wherein the first security key is based at least in part on a first set of physical layer parameter values, and the second security key is based at least in part on a second set of physical layer parameter values (e.g., using antenna 234 or 252, modem 232 or 254, MIMO detector 236 or 256, receive processor 238 or 258, controller/processor 240 or 280, memory 242 or 282, or the like).

In some aspects, the first network node includes means for transmitting a first communication of a plurality of communications associated with at least one physical layer channel, wherein a first set of the plurality of communications includes the at least one communication and is secured by a first security key of a plurality of security keys (e.g., using controller/processor 240 or 280, transmit processor 220 or 264, TX MIMO processor 230 or 266, modem 232 or 254, antenna 234 or 252, memory 242 or 282, or the like); and/or means for transmitting a second communication of the plurality of communications, wherein a second set of the plurality of communications is secured by a second security key of the plurality of security keys (e.g., using controller/processor 240 or 280, transmit processor 220 or 264, TX MIMO processor 230 or 266, modem 232 or 254, antenna 234 or 252, memory 242 or 282, or the like). In some aspects, the means for the first network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the first network node to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

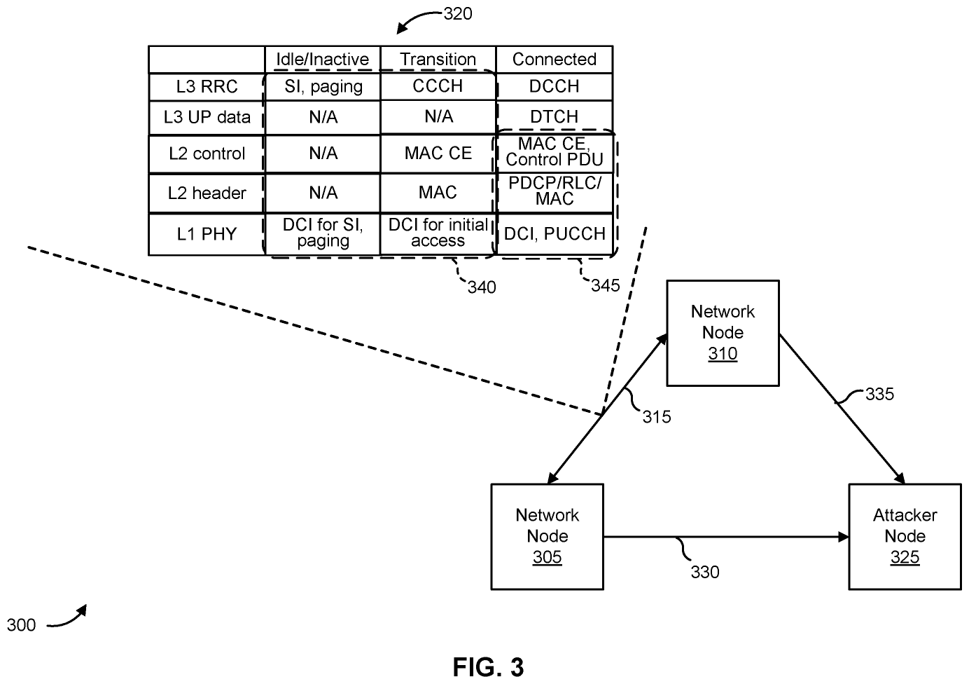

FIG. 3 is a diagram illustrating an example of network communications, in accordance with the present disclosure. As shown, a network node 305 and a network node 310 can communicate with one another. The network node 305 and the network node 310 can communicate via an access network, a sidelink network, and/or any other type of wireless network.

The network node 305 and the network node 310 can communicate using a network 315 that employs a protocol stack, as represented in the grid 320. For example, the protocol stack can include a set of layers, referred to as Layer 1 (shown as “L1”), Layer 2 (shown as “L2”), and Layer 3 (shown as “L3”). L1 can refer to a physical layer (often referred to as a “PHY” or a “PHY layer”). L2 can include protocol layers associated with control and protocol layers associated with a packet header. The L2 layers can include medium access control (MAC) layers, radio link control (RLC) layers, packet data convergence protocol (PDCP) layers, and service data adaptation protocol (SDAP) layers. L3 can include an RRC layer and a user plane (UP) layer.

Generally, a first layer is referred to as higher than a second layer if the first layer is further from the PHY layer than the second layer. For example, the Layer 1 can be referred to as a lowest layer, and the Layer 2 can be referred to as higher than the Layer 1 and lower than the Layer 3. An application (APP) layer, not shown in FIG. 3, may be higher than the Layer 2. In some cases, an entity (e.g., a component of a network node 305 and/or 310) can handle the services and functions of a given layer (e.g., a PDCP entity may handle the services and functions of the PDCP layer), though the description herein refers to the layers themselves as handling the services and functions.

The RRC layer (shown as “L3 RRC”) can handle communications related to configuring and operating a network node 305 (e.g., a UE 120). For example, as shown, during an idle state or an inactive state of the network node 305, the RRC layer can handle, among other possible functions, system information broadcast and paging. Within a transition mode (e.g., a transition from an idle mode to a connected mode), the RRC layer can be used to provide a common control channel (CCCH), and within a connected mode, the RRC layer can be used to provide a dedicated control channel (DCCH). The UP aspects of the Layer 3 (shown as “L3 UP data”) can be used, in a connected mode, to provide a dedicated traffic channel (DTCH).

Control aspects of the Layer 2 (shown as “L2 control”) can be used, in a transition mode, to facilitate transmitting and receiving MAC control elements (MAC CEs) and, in a connected mode, to control PDCP protocol data unit (PDU) routing. The header aspects of the Layer 2 (shown as “L2 header”) can be used, in a transition mode, to facilitate MAC operations and, in a connected mode, to facilitate PDCP operations, RLC operations, and MAC operations.

The Layer 1 (shown as “L1 PHY”) can be used, in an idle mode or an inactive mode, to facilitate transmission of DCI and paging messages. In a transition mode, the Layer I can be used for DCI transmission to facilitate initial access to an access network. In a connected mode, the Layer I can be used to facilitate transmitting and receiving DCI and physical uplink control channel (PUCCH) communications.

Secure communications are important in wireless communications such as those depicted in FIG. 3. Moreover, the development of the IoT can make security even more important, since IoT involves many interconnected devices. In some cases, an attacker node 325 can perform attacks on the network 315. While the DCCH and DTCH channels generally are protected from attacks, many other channels and communications can be more vulnerable to attacks. In some cases, for example, the attacker node 325 can eavesdrop on communications from the network and receive communications 330 transmitted by the network node 305 and/or communications 335 transmitted by the network node 310.

In some cases, for example, the attacker node 325 can use information obtained from eavesdropping to pose as the network node 305 and/or the network node 310, interrupting the flow of legitimate communications. As shown for example, an attacker node 325 posing as an access network node can cause the set 340 of functions in the first two columns of the grid 320 to be rendered out of service. An attacker node 325 posing as an access network node also can degrade throughput with respect to the set 345 of functions associated with Layer 2 and Layer 1 in connected mode. Physical layer attacks of control information can cause communication disruptions, consumption of useful communication resources, transmission delays and/or other negative impacts to network performance.

Some aspects of the techniques and apparatuses described herein provide for securing communications using security keys based at least in part on physical layer parameters. For example, in some aspects, communications associated with the physical layer may be secured using a security key that is based at least in part on a set of physical layer parameter values. In some aspects, a security key may be used to secure a channel and/or a reference signal. For example, in some aspects, each channel of a plurality of channels may be secured by a different security key of a plurality of security keys. Similarly, in some aspects, each reference signal of a plurality of reference signals may be secured by a different security key of a plurality of security keys. In this way, physical layer communications may be secured using security keys that are based on characteristics of the physical channels themselves. Because a physical channel between the network node 305 and the network node 310 will be different than a physical channel between the attacker node 325 and either of the network node 305 and/or the network node 310, some aspects described herein may facilitate protecting communications from attack. As a result, some aspects may reduce communication disruptions, consumption of resources, and/or transmission delays, thereby having a positive impact on network performance.

As indicated above, FIG. 3 is provided as an example. Other examples may differ from what is described with regard to FIG. 3.

FIG. 4 is a diagram illustrating an example 400 of securing communications using security keys based at least in part on physical layer parameters, in accordance with the present disclosure. As shown in FIG. 4, a receiver network node 405 and a transmitter network node 410 may communicate with one another. The receiver network node 405 and the transmitter network node 410 may communicate via a wireless network. In some aspects, the receiver network node 405 may include a UE, a repeater, a relay device, and/or an IAB node, among other examples. In some aspects, the transmitter network node 410 may include a base station, a non-terrestrial network node, a roadside unit, an industrial controller, an IAB node, and/or a relay device, among other examples. In some aspects, the receiver network node 405 may be referred to as a “first network node” (e.g., for purposes of a discussion of operations from the perspective of the receiver network node 405) and the transmitter network node 410 may be referred to as a “second network node.” In some other aspects, the transmitter network node 410 may be referred to as a “first network node” (e.g., for purposes of a discussion of operations from the perspective of the transmitter network node 410), and the receiver network node 405 may be referred to as a “second network node.”

As shown by reference number 415, the transmitter network node 410 may transmit, and the receiver network node 405 may receive, a configuration. In some aspects, the configuration may include a number of key configurations. For example, in some aspects, the configuration may include a first key configuration and a second key configuration. The first key configuration may include a first set of key configuration parameters, and the second key configuration may include a second set of key configuration parameters. In this way, for example, different security keys may be generated and used with different channels and/or reference signals, among other examples. In some aspects, the first set of key configuration parameters may indicate a first security key refresh time, and the second set of key configuration parameters may indicate a second security key refresh time. A security key refresh time may represent a time during which a security key is valid, so that, at the end of the time period, the security key is refreshed (e.g., re-generated using updated configuration parameters). Each security key may have a different refresh time.

In some aspects, a key configuration may include a key derivation function (KDF). For example, in some aspects, the KDF may be based on a hash-based message authentication code (HMAC)-secure hash algorithm (SHA)-256 (HMAC-SHA-256). In some aspects, the KDF may include any number of other types of functions that may be configured to generate a security key based at least in part on one or more physical layer parameter values as input. In some aspects, the first set of key configuration parameters may indicate a first set of KDF inputs corresponding to the first KDF, and the second set of key configuration parameters may indicate a second set of KDF inputs corresponding to the second KDF. The second set of KDF inputs may be different than the first set of KDF inputs, thereby facilitating generation of two different keys.

In some aspects, a set of physical layer parameter values that may be used as inputs to a KDF may indicate a component carrier index, a bandwidth part value, a resource pool index associated with a resource pool configured for sidelink operations, a resource pool parameter value associated with the resource pool, a time division duplexing (TDD) pattern parameter value, a frame index, a slot index, a sub-slot index, a slot offset, a reference signal configuration, a periodic signaling parameter value associated with a periodic signal configuration, a resource element frequency index, and/or a resource element time index, among other examples. In some aspects, for example, the resource pool parameter value may indicate a power control parameter value, a channel busy ratio, a subcarrier spacing, a number of configured shared channel symbols, a number of configured subchannels, a configured subchannel size, and/or a starting subchannel, among other examples. In some aspects, the TDD pattern parameter value may indicate a TDD pattern index, a number of configured downlink symbols, a number of configured uplink symbols, and/or a number of configured flexible symbols, among other examples.

In some aspects, the periodic signaling parameter value may indicate a semi-persistent scheduling (SPS) index, a configured grant (CG) index, an SPS periodicity, a CG periodicity, a security key seed associated with the periodic signal configuration, and/or an occasion index corresponding to an occasion occurring after a periodic signaling activation time, among other examples. The periodic signaling activation time may correspond to a DCI activation type. In some aspects, the periodic signaling activation time may correspond to an RRC activation type.

In some aspects, the configuration may include a reference signal configuration (e.g., in aspects in which security keys are assigned to specified reference signals). For example, the reference signal configuration may correspond to a demodulation reference signal, a sounding reference signal, and/or a channel state information reference signal, among other examples.

In some aspects, the configuration may include a security key pattern configuration that indicates one or more bundle patterns. For example, for securing two different channels and/or reference signals with two different keys, security key pattern configuration may indicate a first bundle pattern and a second bundle pattern. A bundle pattern may refer to a pattern of grouped (“bundled”) resources within a set of resources. The resources may include time domain resources and/or frequency domain resources. For example, as shown in FIG. 4, a resource element grid 420 may include a number of REs (shown as boxes) grouped into bundles (illustrated as sets of boxes having a same shading pattern). A bundle may be defined according to the time domain resources and/or frequency domain resources associated with the REs included in the bundle. In some aspects, instead of associating security keys with different channels and/or reference signals, security keys may be associated with different bundles. For example, a first security key may be associated with a first bundle and a second security key may be associated with a second bundle.

The security key patterns may be configured (e.g., using RRC messages and/or MAC CEs, preconfigured (loaded onto network devices at a manufacturing phase)), and/or defined in a wireless communication standard. In some aspects, a bundle index associated with a bundle to be secured using a security key may be used as an input to the corresponding KDF. In some aspects, the configuration may include a bundle configuration that indicates a set of bundle patterns for access link communications. In some aspects, the bundle configuration may indicate a set of bundles associated with a sidelink resource pool.

As shown by reference number 425, the transmitter network node 410 may transmit, and the receiver network node 405 may receive, at least one communication of a plurality of communications. The at least one communication may be associated with at least one physical layer channel. A first set of the plurality of communications may include the at least one communication and may be secured by a first security key of a plurality of security keys, and a second set of the plurality of communications may be secured by a second security key of the plurality of security keys. In some aspects, the first set of communications may correspond to a first resource element bundle (e.g., corresponding to a first bundle pattern) and the second set of communications may correspond to a second resource element bundle (e.g., corresponding to a second bundle pattern).

In some aspects, the first set of communications may correspond to a first priority level and the second set of communications may correspond to a second priority level. A first security key refresh time associated with the first set of communications may be shorter than a second security key refresh time associated with the second set of communications. For example, the first priority level may be higher than the second priority level and, therefore, the associated set of communications may include communications that should be more secure than the second set of communications. By associating higher priority communications with shorter security key refresh times, corresponding security keys may be changed more often, making attacks on these communications more difficult. The priority level may relate, for example, to quality of service (QOS) and/or security application requirements, among other examples.

As shown by reference number 430, the receiver network node 405 may decrypt the at least one communication. For example, the receiver network node 405 may decrypt the at least one communication based at least in part on the first security key. In some aspects, as explained above, the first security key may be based at least in part on a first set of physical layer parameter values. In some aspects, for example, the receiver network node 405 may determine an activated bundle pattern of a first bundle pattern and a second bundle pattern. In some aspects, for example, the receiver network node 405 may receive an indication of the activated bundle pattern. The transmitter network node 410 may transmit the indication of the activated bundle pattern using an indication signal. The indication signal may include a layer 3 signal, a layer 2 signal, or a layer 1 signal.

In some aspects, the first security key may include a first subset of security key bits of a set of security key bits corresponding to a security key stream based at least in part on a KDF. A second security key may include a second subset of security key bits of the set of security key bits. For example, as shown, the receiver network node 405 may generate a stream 435 of security key bits. The receiver network node 405 may map the security key bits of the stream 435 to REs based at least in part on a corresponding data modulation order quadrature amplitude modulation (QAM) (e.g., a current modulation and coding scheme). As shown, for example, if the communication channel is configured with 16 QAM, then the first four security key bits 440 will be mapped to a first RE 445, the next four security key bits 450 will be mapped to a next RE 455, and so on.

In some aspects, the at least one communication may include a QAM signal, and the first subset of security key bits may be appended to the QAM signal. In some aspects, the at least one communication may include a QAM signal, and the QAM signal may be phase shift rotated based at least in part on the first subset of security key bits. In some aspects, the at least one communication may include a network coded QAM signal representing an exclusive-OR (XOR) of the first subset of security key bits with a set of data bits.

In some aspects, decrypting the at least one communication may include mapping the set of security key bits of the security key stream to a plurality of communications of the at least one communication, refreshing the KDF to determine an updated security key stream, and applying a subset of security key bits of a set of security key bits corresponding to the updated security key stream to an additional communication of the at least one communication. In some aspects, one or more mapping rules may determine the mapping of security key bits. The mapping rule may be configured using a mapping configuration and/or defined in a wireless communication standard.

As indicated above, FIG. 4 is provided as an example. Other examples may differ from what is described with regard to FIG. 4.

FIG. 5 is a diagram illustrating an example process 500 performed, for example, by a first network node, in accordance with the present disclosure. Example process 500 is an example where the first network node (e.g., receiver network node 405) performs operations associated with securing communications using security keys based at least in part on physical layer parameters.

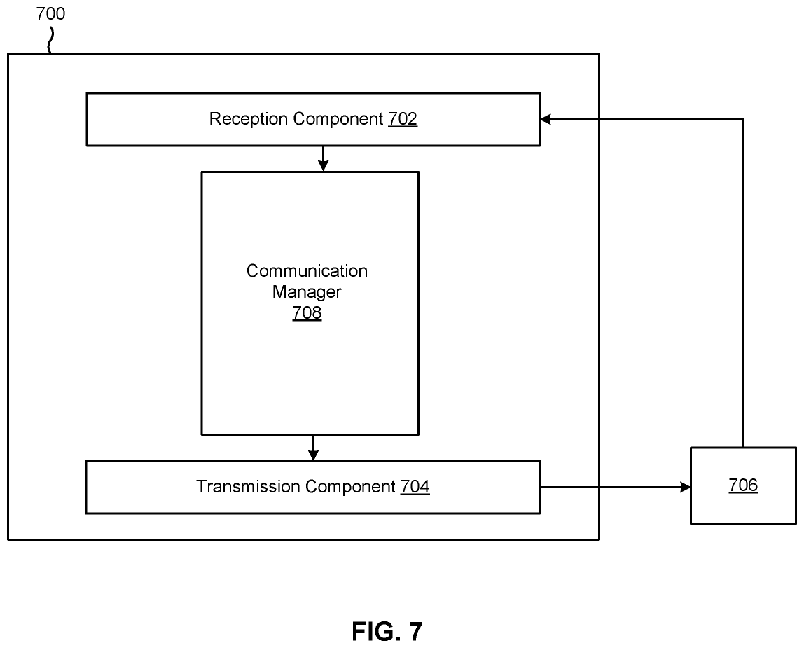

As shown in FIG. 5, in some aspects, process 500 may include receiving at least one communication of a plurality of communications associated with at least one physical layer channel, wherein a first set of the plurality of communications includes the at least one communication and is secured by a first security key of a plurality of security keys, and a second set of the plurality of communications is secured by a second security key of the plurality of security keys (block 510). For example, the first network node (e.g., using communication manager 708 and/or reception component 702, depicted in FIG. 7) may receive at least one communication of a plurality of communications associated with at least one physical layer channel, wherein a first set of the plurality of communications includes the at least one communication and is secured by a first security key of a plurality of security keys, and a second set of the plurality of communications is secured by a second security key of the plurality of security keys, as described above, for example, with reference to FIG. 4.

As further shown in FIG. 5, in some aspects, process 500 may include decrypting the at least one communication based at least in part on the first security key, wherein the first security key is based at least in part on a first set of physical layer parameter values, and the second security key is based at least in part on a second set of physical layer parameter values (block 520). For example, the first network node (e.g., using communication manager 708 and/or reception component 702, depicted in FIG. 7) may decrypt the at least one communication based at least in part on the first security key, wherein the first security key is based at least in part on a first set of physical layer parameter values, and the second security key is based at least in part on a second set of physical layer parameter values, as described above, for example, with reference to FIG. 4.

Process 500 may include additional aspects, such as any single aspect or any combination of aspects described below and/or in connection with one or more other processes described elsewhere herein.

In some aspects, the first set of physical layer parameter values indicates a component carrier index, a bandwidth part value, a resource pool index associated with a resource pool configured for sidelink operations, a resource pool parameter value associated with the resource pool, a TDD pattern parameter value, a frame index, a slot index, a sub-slot index, a slot offset, a reference signal configuration, a periodic signaling parameter value associated with a periodic signal configuration, a resource element frequency index, a resource element time index, or any combination thereof. In some aspects, the resource pool parameter value indicates at least one of a power control parameter value, a channel busy ratio, a subcarrier spacing, a number of configured shared channel symbols, a number of configured subchannels, a configured subchannel size, or a starting subchannel. In some aspects, the TDD pattern parameter value indicates at least one of a TDD pattern index, a number of configured downlink symbols, a number of configured uplink symbols, or a number of configured flexible symbols.

In some aspects, the reference signal configuration corresponds to at least one of a demodulation reference signal, a sounding reference signal, or a channel state information reference signal. In some aspects, the periodic signaling parameter value indicates at least one of an SPS index, a CG index, an SPS periodicity, a CG periodicity, a security key seed associated with the periodic signal configuration, or an occasion index corresponding to an occasion occurring after a periodic signaling activation time. In some aspects, the periodic signaling activation time corresponds to a DCI activation type. In some aspects, the periodic signaling activation time corresponds to an RRC activation type.

In some aspects, the first security key is based at least in part on a first key configuration having a first set of key configuration parameters, and the second security key is based at least in part on a second key configuration having a second set of key configuration parameters. In some aspects, the first key configuration includes a first KDF, the first set of key configuration parameters indicating a first set of KDF inputs corresponding to the first KDF, and the second key configuration includes a second KDF, the second set of key configuration parameters indicating a second set of KDF inputs corresponding to the second KDF. In some aspects, the first set of KDF inputs is different than the second set of KDF inputs. In some aspects, the first set of key configuration parameters indicates a first security key refresh time and the second set of key configuration parameters indicates a second security key refresh time.

In some aspects, the first set of communications corresponds to a first priority level and the second set of communications corresponds to a second priority level, and the first security key refresh time is shorter than the second security key refresh time based at least in part on the first priority level being higher than the second priority level. In some aspects, the first set of communications corresponds to a first resource element bundle associated with the first security key and the second set of communications corresponds to a second resource element bundle associated with the second security key. In some aspects, the first resource element bundle corresponds to a first set of allocated resources and the second resource element bundle corresponds to a second set of allocated resources.

In some aspects, the first set of allocated resources comprises at least one of a first allocated time resource or a first allocated frequency resource, and the second set of allocated resources comprises at least one of a second allocated time resource or a second allocated frequency resource. In some aspects, the first resource element bundle corresponds to a first bundle pattern and the second resource element corresponds to a second bundle pattern. In some aspects, process 500 includes receiving a security key pattern configuration that indicates the first bundle pattern and the second bundle pattern. In some aspects, receiving the security key pattern configuration comprises receiving at least one of a radio resource control message that includes the security key pattern configuration or receiving a medium access control control element that includes the security key pattern configuration. In some aspects, a wireless communication standard indicates the first bundle pattern and the second bundle pattern.

In some aspects, the first bundle pattern and the second bundle pattern are associated with a sidelink resource pool. In some aspects, process 500 includes determining an activated bundle pattern of the first bundle pattern and the second bundle pattern. In some aspects, determining the activated bundle pattern comprises receiving an indication of the activated bundle pattern. In some aspects, receiving, from a second network node, the indication of the activated bundle pattern comprises receiving an indication signal, the indication signal comprising a layer 3 signal, a layer 2 signal, or a layer 1 signal.

In some aspects, process 500 includes receiving a bundle configuration that indicates a set of bundle patterns for access link communications, wherein the set of bundle patterns includes the first bundle pattern and the second bundle pattern. In some aspects, process 500 includes receiving an indication that indicates that the first bundle pattern is an activated bundle pattern. In some aspects, the second network node is a base station. In some aspects, a first bundle index corresponds to the first resource element bundle and a second bundle index corresponds to the second resource element bundle.

In some aspects, the first security key is based at least in part on a first key configuration having a first set of key configuration parameters, and the second security key is based at least in part on a second key configuration having a second set of key configuration parameters, wherein the first key configuration includes a first KDF, wherein a first set of KDF inputs corresponding to the first KDF comprises the first bundle index, and the second key configuration includes a second KDF, wherein a second set of KDF inputs corresponding to the second KDF comprises the second bundle index. In some aspects, the first security key comprises a first subset of security key bits of a set of security key bits corresponding to a security key stream based at least in part on a KDF, and the second security key comprises a second subset of security key bits of the set of security key bits. In some aspects, a number of security key bits in the first subset of security key bits is based at least in part on a modulation order. In some aspects, the first subset of security key bits is mapped to a first resource element of a plurality of resource elements, and the second subset of security key bits is mapped to a second resource element of the plurality of resource elements.

In some aspects, the at least one communication comprises a QAM signal, wherein the first subset of security key bits is appended to the QAM signal. In some aspects, the at least one communication comprises a QAM signal, and the QAM signal is phase shift rotated based at least in part on the first subset of security key bits. In some aspects, the at least one communication comprises a network coded QAM signal representing an XOR of the first subset of security key bits with a set of data bits.

In some aspects, decrypting the at least one communication comprises mapping the set of security key bits of the security key stream to a plurality of communications of the at least one communication, and mapping the set of security key bits comprises applying the first subset of security key bits to a first communication of the at least one communication, applying the second subset of security key bits to a second communication of the at least one communication, refreshing the KDF to determine an updated security key stream, and applying a subset of security key bits of a set of security key bits corresponding to the updated security key stream to a third communication of the at least one communication. In some aspects, mapping the set of security key bits comprises mapping the set of security key bits based at least in part on a mapping rule. In some aspects, process 500 includes receiving a mapping configuration that indicates the mapping rule.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a first network node, in accordance with the present disclosure. Example process 600 is an example where the first network node (e.g., transmitter network node 410) performs operations associated with securing communications using security keys based at least in part on physical layer parameters.

As shown in FIG. 6, in some aspects, process 600 may include transmitting a first communication of a plurality of communications associated with at least one physical layer channel, wherein a first set of the plurality of communications includes the at least one communication and is secured by a first security key of a plurality of security keys (block 610). For example, the first network node (e.g., using communication manager 708 and/or transmission component 704, depicted in FIG. 7) may transmit a first communication of a plurality of communications associated with at least one physical layer channel, wherein a first set of the plurality of communications includes the at least one communication and is secured by a first security key of a plurality of security keys, as described above, for example, with reference to FIG. 4.

As further shown in FIG. 6, in some aspects, process 600 may include transmitting a second communication of the plurality of communications, wherein a second set of the plurality of communications is secured by a second security key of the plurality of security keys (block 620). For example, the first network node (e.g., using communication manager 708 and/or transmission component 704, depicted in FIG. 7) may transmit a second communication of the plurality of communications, wherein a second set of the plurality of communications is secured by a second security key of the plurality of security keys, as described above, for example, with reference to FIG. 4.

Process 600 may include additional aspects, such as any single aspect or any combination of aspects described below and/or in connection with one or more other processes described elsewhere herein.

In some aspects, the first set of physical layer parameter values indicates a component carrier index, a bandwidth part value, a resource pool index associated with a resource pool configured for sidelink operations, a resource pool parameter value associated with the resource pool, a TDD pattern parameter value, a frame index, a slot index, a sub-slot index, a slot offset, a reference signal configuration, a periodic signaling parameter value associated with a periodic signal configuration, a resource element frequency index, a resource element time index, or any combination thereof. In some aspects, the resource pool parameter value indicates at least one of a power control parameter value, a channel busy ratio, a subcarrier spacing, a number of configured shared channel symbols, a number of configured subchannels, a configured subchannel size, or a starting subchannel. In some aspects, the TDD pattern parameter value indicates at least one of a TDD pattern index, a number of configured downlink symbols, a number of configured uplink symbols, or a number of configured flexible symbols. In some aspects, the reference signal configuration corresponds to at least one of a demodulation reference signal, a sounding reference signal, or a channel state information reference signal. In some aspects, the periodic signaling parameter value indicates at least one of an SPS index, a CG index, an SPS periodicity, a CG periodicity, a security key seed associated with the periodic signal configuration, or an occasion index corresponding to an occasion occurring after a periodic signaling activation time. In some aspects, the periodic signaling activation time corresponds to a DCI activation type. In some aspects, the periodic signaling activation time corresponds to an RRC activation type.

In some aspects, the first security key is based at least in part on a first key configuration having a first set of key configuration parameters, and the second security key is based at least in part on a second key configuration having a second set of key configuration parameters. In some aspects, the first key configuration includes a first KDF, the first set of key configuration parameters indicating a first set of KDF inputs corresponding to the first KDF, and the second key configuration includes a second KDF, the second set of key configuration parameters indicating a second set of KDF inputs corresponding to the second KDF. In some aspects, the first set of KDF inputs is different than the second set of KDF inputs. In some aspects, the first set of key configuration parameters indicates a first security key refresh time and the second set of key configuration parameters indicates a second security key refresh time. In some aspects, the first set of communications corresponds to a first priority level and the second set of communications corresponds to a second priority level, and the first security key refresh time is shorter than the second security key refresh time based at least in part on the first priority level being higher than the second priority level.

In some aspects, the first set of communications corresponds to a first resource element bundle associated with the first security key and the second set of communications corresponds to a second resource element bundle associated with the second security key. In some aspects, the first resource element bundle corresponds to a first set of allocated resources and the second resource element bundle corresponds to a second set of allocated resources. In some aspects, the first set of allocated resources comprises at least one of a first allocated time resource or a first allocated frequency resource, and the second set of allocated resources comprises at least one of a second allocated time resource or a second allocated frequency resource. In some aspects, the first resource element bundle corresponds to a first bundle pattern and the second resource element bundle corresponds to a second bundle pattern.

In some aspects, process 600 includes transmitting a security key pattern configuration that indicates the first bundle pattern and the second bundle pattern. In some aspects, transmitting the security key pattern configuration comprises transmitting at least one of an RRC message that includes the security key pattern configuration or transmitting a MAC CE that includes the security key pattern configuration. In some aspects, a wireless communication standard indicates the first bundle pattern and the second bundle pattern.

In some aspects, the first bundle pattern and the second bundle pattern are associated with a sidelink resource pool. In some aspects, process 600 includes determining an activated bundle pattern of the first bundle pattern and the second bundle pattern. In some aspects, process 600 includes transmitting an indication of the activated bundle pattern. In some aspects, transmitting the indication of the activated bundle pattern comprises transmitting an indication signal, the indication signal comprising a layer 3 signal, a layer 2 signal, or a layer 1 signal.

In some aspects, process 600 includes transmitting a bundle configuration that indicates a set of bundle patterns for access link communications, wherein the set of bundle patterns includes the first bundle pattern and the second bundle pattern. In some aspects, process 600 includes transmitting an indication that indicates that the first bundle pattern is an activated bundle pattern. In some aspects, the first network node is a base station. In some aspects, a first bundle index corresponds to the first resource element bundle and a second bundle index corresponds to the second resource element bundle. In some aspects, the first security key is based at least in part on a first key configuration having a first set of key configuration parameters, and the second security key is based at least in part on a second key configuration having a second set of key configuration parameters, wherein the first key configuration includes a first KDF, wherein a first set of KDF inputs corresponding to the first KDF comprises the first bundle index, and the second key configuration includes a second KDF, wherein a second set of KDF inputs corresponding to the second KDF comprises the second bundle index.

In some aspects, the first security key comprises a first subset of security key bits of a set of security key bits corresponding to a security key stream based at least in part on a KDF, and the second security key comprises a second subset of security key bits of the set of security key bits. In some aspects, a number of security key bits in the first subset of security key bits is based at least in part on a modulation order. In some aspects, the first subset of security key bits is mapped to a first resource element of a plurality of resource elements, and the second subset of security key bits is mapped to a second resource element of the plurality of resource elements. In some aspects, the at least one communication comprises a QAM signal, wherein the first subset of security key bits is appended to the QAM signal. In some aspects, the at least one communication comprises a QAM signal, and the QAM signal is phase shift rotated based at least in part on the first subset of security key bits. In some aspects, the at least one communication comprises a network coded QAM signal representing an XOR of the first subset of security key bits with a set of data bits.

In some aspects, process 600 includes encrypting the at least one communication, wherein encrypting the at least one communication comprises mapping the set of security key bits of the security key stream to a plurality of communications of the at least one communication, and mapping the set of security key bits comprises applying the first subset of security key bits to a first communication of the at least one communication, applying the second subset of security key bits to a second communication of the at least one communication, refreshing the KDF to determine an updated security key stream, and applying a subset of security key bits of a set of security key bits corresponding to the updated security key stream to a third communication of the at least one communication. In some aspects, mapping the set of security key bits comprises mapping the set of security key bits based at least in part on a mapping rule. In some aspects, process 600 includes transmitting a mapping configuration that indicates the mapping rule.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a network node, or a network node may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 708.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5, process 600 of FIG. 6, or a combination thereof. In some aspects, the apparatus 700 and/or one or more components shown in FIG. 7 may include one or more components of the UE and/or the base station described in connection with FIG. 2. Additionally. or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE and/or the base station described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE and/or the base station described in connection with FIG. 2. In some aspects, the transmission component 704 may be co-located with the reception component 702 in a transceiver.

The reception component 702 may receive at least one communication of a plurality of communications associated with at least one physical layer channel, wherein a first set of the plurality of communications includes the at least one communication and is secured by a first security key of a plurality of security keys, and wherein a second set of the plurality of communications is secured by a second security key of the plurality of security keys. The communication manager 708 and/or the reception component 702 may decrypt the at least one communication based at least in part on the first security key, wherein the first security key is based at least in part on a first set of physical layer parameter values, and wherein the second security key is based at least in part on a second set of physical layer parameter values.

In some aspects, the communication manager 708 may be, be similar to, include, or be included in the communication manager 140 and/or the communication manager 150 depicted in FIGS. 1 and 2. In some aspects, the communication manager 708 may include one or more antennas, a modem, a controller/processor, a memory, or a combination thereof, of the UE and/or the base station described in connection with FIG. 2. In some aspects, the communication manager 708 may include the reception component 702 and/or the transmission component 704.

The reception component 702 may receive a security key pattern configuration that indicates the first bundle pattern and the second bundle pattern. The communication manager 708 may determine an activated bundle pattern of the first bundle pattern and the second bundle pattern. The reception component 702 may receive a bundle configuration that indicates a set of bundle patterns for access link communications, wherein the set of bundle patterns includes the first bundle pattern and the second bundle pattern. The reception component 702 may receive an indication that indicates that the first bundle pattern is an activated bundle pattern. The reception component 702 may receive a mapping configuration that indicates the mapping rule.

The transmission component 704 may transmit a first communication of a plurality of communications associated with at least one physical layer channel, wherein a first set of the plurality of communications includes the at least one communication and is secured by a first security key of a plurality of security keys. The transmission component 704 may transmit a second communication of the plurality of communications, wherein a second set of the plurality of communications is secured by a second security key of the plurality of security keys.

The transmission component 704 may transmit a security key pattern configuration that indicates the first bundle pattern and the second bundle pattern. The communication manager 708 may determine an activated bundle pattern of the first bundle pattern and the second bundle pattern. The transmission component 704 may transmit an indication of the activated bundle pattern. The transmission component 704 may transmit a bundle configuration that indicates a set of bundle patterns for access link communications, wherein the set of bundle patterns includes the first bundle pattern and the second bundle pattern. The transmission component 704 may transmit an indication that indicates that the first bundle pattern is an activated bundle pattern.

The communication manager 708 and/or the transmission component 704 may encrypt the at least one communication, wherein encrypting the at least one communication comprises mapping the set of security key bits of the security key stream to a plurality of communications of the at least one communication, and wherein mapping the set of security key bits comprises applying the first subset of security key bits to a first communication of the at least one communication: applying the second subset of security key bits to a second communication of the at least one communication: refreshing the KDF to determine an updated security key stream; and applying a subset of security key bits of a set of security key bits corresponding to the updated security key stream to a third communication of the at least one communication. The transmission component 704 may transmit a mapping configuration that indicates the mapping rule.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed at a first network node, comprising: receiving at least one communication of a plurality of communications associated with at least one physical layer channel, wherein a first set of the plurality of communications includes the at least one communication and is secured by a first security key of a plurality of security keys, and wherein a second set of the plurality of communications is secured by a second security key of the plurality of security keys; and decrypting the at least one communication based at least in part on the first security key, wherein the first security key is based at least in part on a first set of physical layer parameter values, and wherein the second security key is based at least in part on a second set of physical layer parameter values.
Aspect 2: The method of Aspect 1, wherein the first set of physical layer parameter values indicates: a component carrier index, a bandwidth part value, a resource pool index associated with a resource pool configured for sidelink operations, a resource pool parameter value associated with the resource pool, a time division duplexing (TDD) pattern parameter value, a frame index, a slot index, a sub-slot index, a slot offset, a reference signal configuration, a periodic signaling parameter value associated with a periodic signal configuration, a resource element frequency index, a resource element time index, or any combination thereof.
Aspect 3: The method of Aspect 2, wherein the resource pool parameter value indicates at least one of: a power control parameter value, a channel busy ratio, a subcarrier spacing, a number of configured shared channel symbols, a number of configured subchannels, a configured subchannel size, or a starting subchannel.
Aspect 4: The method of either of Aspects 2 or 3, wherein the TDD pattern parameter value indicates at least one of: a TDD pattern index, a number of configured downlink symbols, a number of configured uplink symbols, or a number of configured flexible symbols.
Aspect 5: The method of any of Aspects 2-4, wherein the reference signal configuration corresponds to at least one of: a demodulation reference signal, a sounding reference signal, or a channel state information reference signal.
Aspect 6: The method of any of Aspects 2-5, wherein the periodic signaling parameter value indicates at least one of: a semi-persistent scheduling (SPS) index, a configured grant (CG) index, an SPS periodicity, a CG periodicity, a security key seed associated with the periodic signal configuration, or an occasion index corresponding to an occasion occurring after a periodic signaling activation time.
Aspect 7: The method of Aspect 6, wherein the periodic signaling activation time corresponds to a downlink control information activation type.
Aspect 8: The method of either of Aspects 6 or 7, wherein the periodic signaling activation time corresponds to a radio resource control activation type.
Aspect 9: The method of any of Aspects 1-8, wherein the first security key is based at least in part on a first key configuration having a first set of key configuration parameters, and wherein the second security key is based at least in part on a second key configuration having a second set of key configuration parameters.
Aspect 10: The method of Aspect 9, wherein the first key configuration includes a first key derivation function (KDF), the first set of key configuration parameters indicating a first set of KDF inputs corresponding to the first KDF, and wherein the second key configuration includes a second KDF, the second set of key configuration parameters indicating a second set of KDF inputs corresponding to the second KDF.
Aspect 11: The method of Aspect 10, wherein the first set of KDF inputs is different than the second set of KDF inputs.
Aspect 12: The method of any of Aspects 9-11, wherein the first set of key configuration parameters indicates a first security key refresh time and the second set of key configuration parameters indicates a second security key refresh time.
Aspect 13: The method of Aspect 12, wherein the first set of communications corresponds to a first priority level and the second set of communications corresponds to a second priority level, and wherein the first security key refresh time is shorter than the second security key refresh time based at least in part on the first priority level being higher than the second priority level.
Aspect 14: The method of any of Aspects 1-13, wherein the first set of communications corresponds to a first resource element bundle associated with the first security key and the second set of communications corresponds to a second resource element bundle associated with the second security key.
Aspect 15: The method of Aspect 14, wherein the first resource element bundle corresponds to a first set of allocated resources and the second resource element bundle corresponds to a second set of allocated resources.
Aspect 16: The method of Aspect 15, wherein the first set of allocated resources comprises at least one of a first allocated time resource or a first allocated frequency resource, and wherein the second set of allocated resources comprises at least one of a second allocated time resource or a second allocated frequency resource.
Aspect 17: The method of any of Aspects 14-16, wherein the first resource element bundle corresponds to a first bundle pattern and the second resource element corresponds to a second bundle pattern.
Aspect 18: The method of Aspect 17, further comprising receiving a security key pattern configuration that indicates the first bundle pattern and the second bundle pattern.
Aspect 19: The method of Aspect 18, wherein receiving the security key pattern configuration comprises receiving at least one of a radio resource control message that includes the security key pattern configuration or receiving a medium access control control element that includes the security key pattern configuration.
Aspect 20: The method of any of Aspects 17-19, wherein a wireless communication standard indicates the first bundle pattern and the second bundle pattern.
Aspect 21: The method of any of Aspects 17-20, wherein the first bundle pattern and the second bundle pattern are associated with a sidelink resource pool.
Aspect 22: The method of Aspect 21, further comprising determining an activated bundle pattern of the first bundle pattern and the second bundle pattern.
Aspect 23: The method of Aspect 22, wherein determining the activated bundle pattern comprises receiving an indication of the activated bundle pattern.
Aspect 24: The method of Aspect 23, wherein receiving, from a second network node, the indication of the activated bundle pattern comprises receiving an indication signal, the indication signal comprising a layer 3 signal, a layer 2 signal, or a layer 1 signal.
Aspect 25: The method of any of Aspects 17-24, further comprising receiving a bundle configuration that indicates a set of bundle patterns for access link communications, wherein the set of bundle patterns includes the first bundle pattern and the second bundle pattern
Aspect 26: The method of Aspect 25, further comprising receiving an indication that indicates that the first bundle pattern is an activated bundle pattern.
Aspect 27: The method of any of Aspects 24-26, wherein the second network node is a base station.
Aspect 28: The method of any of Aspects 14-27, wherein a first bundle index corresponds to the first resource element bundle and a second bundle index corresponds to the second resource element bundle.
Aspect 29: The method of Aspect 28, wherein the first security key is based at least in part on a first key configuration having a first set of key configuration parameters, and wherein the second security key is based at least in part on a second key configuration having a second set of key configuration parameters, wherein the first key configuration includes a first key derivation function (KDF), wherein a first set of KDF inputs corresponding to the first KDF comprises the first bundle index, and wherein the second key configuration includes a second KDF, wherein a second set of KDF inputs corresponding to the second KDF comprises the second bundle index.
Aspect 30: The method of any of Aspects 1-29, wherein the first security key comprises a first subset of security key bits of a set of security key bits corresponding to a security key stream based at least in part on a key derivation function (KDF), and wherein the second security key comprises a second subset of security key bits of the set of security key bits.
Aspect 31: The method of Aspect 30, wherein a number of security key bits in the first subset of security key bits is based at least in part on a modulation order.
Aspect 32: The method of either of Aspects 30 or 31, wherein the first subset of security key bits is mapped to a first resource element of a plurality of resource elements, and wherein the second subset of security key bits is mapped to a second resource element of the plurality of resource elements.
Aspect 33: The method of any of Aspects 30-32, wherein the at least one communication comprises a quadrature amplitude modulation (QAM) signal, wherein the first subset of security key bits is appended to the QAM signal.
Aspect 34: The method of any of Aspects 30-33, wherein the at least one communication comprises a quadrature amplitude modulation (QAM) signal, and wherein the QAM signal is phase shift rotated based at least in part on the first subset of security key bits.
Aspect 35: The method of any of Aspects 30-34, wherein the at least one communication comprises a network coded quadrature amplitude modulation (QAM) signal representing an exclusive-OR (XOR) of the first subset of security key bits with a set of data bits.
Aspect 36: The method of any of Aspects 30-35, wherein decrypting the at least one communication comprises mapping the set of security key bits of the security key stream to a plurality of communications of the at least one communication, and wherein mapping the set of security key bits comprises: applying the first subset of security key bits to a first communication of the at least one communication: applying the second subset of security key bits to a second communication of the at least one communication: refreshing the KDF to determine an updated security key stream; and applying a subset of security key bits of a set of security key bits corresponding to the updated security key stream to a third communication of the at least one communication.
Aspect 37: The method of Aspect 36, wherein mapping the set of security key bits comprises mapping the set of security key bits based at least in part on a mapping rule.
Aspect 38: The method of Aspect 37, further comprising receiving a mapping configuration that indicates the mapping rule.
Aspect 39: A method of wireless communication performed at a second network node, comprising: transmitting a first communication of a plurality of communications associated with at least one physical layer channel, wherein a first set of the plurality of communications includes the at least one communication and is secured by a first security key of a plurality of security keys; and transmitting a second communication of the plurality of communications, wherein a second set of the plurality of communications is secured by a second security key of the plurality of security keys.
Aspect 40: The method of Aspect 39, wherein the first set of physical layer parameter values indicates: a component carrier index, a bandwidth part value, a resource pool index associated with a resource pool configured for sidelink operations, a resource pool parameter value associated with the resource pool, a time division duplexing (TDD) pattern parameter value, a frame index, a slot index, a sub-slot index, a slot offset, a reference signal configuration, a periodic signaling parameter value associated with a periodic signal configuration, a resource element frequency index, a resource element time index, or any combination thereof.
Aspect 41: The method of Aspect 40, wherein the resource pool parameter value indicates at least one of: a power control parameter value, a channel busy ratio, a subcarrier spacing, a number of configured shared channel symbols, a number of configured subchannels, a configured subchannel size, or a starting subchannel.
Aspect 42: The method of either of Aspects 40 or 41, wherein the TDD pattern parameter value indicates at least one of: a TDD pattern index, a number of configured downlink symbols, a number of configured uplink symbols, or a number of configured flexible symbols.
Aspect 43: The method of any of Aspects 40-42, wherein the reference signal configuration corresponds to at least one of: a demodulation reference signal, a sounding reference signal, or a channel state information reference signal.
Aspect 44: The method of any of Aspects 40-43, wherein the periodic signaling parameter value indicates at least one of: a semi-persistent scheduling (SPS) index, a configured grant (CG) index, an SPS periodicity, a CG periodicity, a security key seed associated with the periodic signal configuration, or an occasion index corresponding to an occasion occurring after a periodic signaling activation time.
Aspect 45: The method of Aspect 44, wherein the periodic signaling activation time corresponds to a downlink control information activation type.
Aspect 46: The method of either of Aspects 44 or 45, wherein the periodic signaling activation time corresponds to a radio resource control activation type.
Aspect 47: The method of any of Aspects 39-46, wherein the first security key is based at least in part on a first key configuration having a first set of key configuration parameters, and wherein the second security key is based at least in part on a second key configuration having a second set of key configuration parameters.
Aspect 48: The method of Aspect 47, wherein the first key configuration includes a first key derivation function (KDF), the first set of key configuration parameters indicating a first set of KDF inputs corresponding to the first KDF, and wherein the second key configuration includes a second KDF, the second set of key configuration parameters indicating a second set of KDF inputs corresponding to the second KDF.
Aspect 49: The method of Aspect 48, wherein the first set of KDF inputs is different than the second set of KDF inputs.
Aspect 50: The method of any of Aspects 47-49, wherein the first set of key configuration parameters indicates a first security key refresh time and the second set of key configuration parameters indicates a second security key refresh time.
Aspect 51: The method of Aspect 50, wherein the first set of communications corresponds to a first priority level and the second set of communications corresponds to a second priority level, and wherein the first security key refresh time is shorter than the second security key refresh time based at least in part on the first priority level being higher than the second priority level.
Aspect 52: The method of any of Aspects 39-51, wherein the first set of communications corresponds to a first resource element bundle associated with the first security key and the second set of communications corresponds to a second resource element bundle associated with the second security key.
Aspect 53: The method of Aspect 52, wherein the first resource element bundle corresponds to a first set of allocated resources and the second resource element bundle corresponds to a second set of allocated resources.
Aspect 54: The method of Aspect 53, wherein the first set of allocated resources comprises at least one of a first allocated time resource or a first allocated frequency resource, and wherein the second set of allocated resources comprises at least one of a second allocated time resource or a second allocated frequency resource.
Aspect 55: The method of any of Aspects 52-54, wherein the first resource element bundle corresponds to a first bundle pattern and the second resource element bundle corresponds to a second bundle pattern.
Aspect 56: The method of Aspect 55, further comprising transmitting a security key pattern configuration that indicates the first bundle pattern and the second bundle pattern.
Aspect 57: The method of Aspect 56, wherein transmitting the security key pattern configuration comprises transmitting at least one of a radio resource control message that includes the security key pattern configuration or transmitting a medium access control control element that includes the security key pattern configuration.
Aspect 58: The method of any of Aspects 55-57, wherein a wireless communication standard indicates the first bundle pattern and the second bundle pattern.
Aspect 59: The method of any of Aspects 55-58, wherein the first bundle pattern and the second bundle pattern are associated with a sidelink resource pool.
Aspect 60: The method of Aspect 59, further comprising determining an activated bundle pattern of the first bundle pattern and the second bundle pattern.
Aspect 61: The method of Aspect 60, further comprising transmitting an indication of the activated bundle pattern.
Aspect 62: The method of Aspect 61, wherein transmitting the indication of the activated bundle pattern comprises transmitting an indication signal, the indication signal comprising a layer 3 signal, a layer 2 signal, or a layer 1 signal.
Aspect 63: The method of any of Aspects 55-62, further comprising transmitting a bundle configuration that indicates a set of bundle patterns for access link communications, wherein the set of bundle patterns includes the first bundle pattern and the second bundle pattern.
Aspect 64: The method of Aspect 63, further comprising transmitting an indication that indicates that the first bundle pattern is an activated bundle pattern.
Aspect 65: The method of Aspect 64, wherein the first network node is a base station.
Aspect 66: The method of any of Aspects 52-65, wherein a first bundle index corresponds to the first resource element bundle and a second bundle index corresponds to the second resource element bundle.
Aspect 67: The method of Aspect 66, wherein the first security key is based at least in part on a first key configuration having a first set of key configuration parameters, and wherein the second security key is based at least in part on a second key configuration having a second set of key configuration parameters, wherein the first key configuration includes a first key derivation function (KDF), wherein a first set of KDF inputs corresponding to the first KDF comprises the first bundle index, and wherein the second key configuration includes a second KDF, wherein a second set of KDF inputs corresponding to the second KDF comprises the second bundle index.
Aspect 68: The method of any of Aspects 39-67, wherein the first security key comprises a first subset of security key bits of a set of security key bits corresponding to a security key stream based at least in part on a key derivation function (KDF), and wherein the second security key comprises a second subset of security key bits of the set of security key bits.
Aspect 69: The method of Aspect 68, wherein a number of security key bits in the first subset of security key bits is based at least in part on a modulation order.
Aspect 70: The method of either of Aspects 68 or 69, wherein the first subset of security key bits is mapped to a first resource element of a plurality of resource elements, and wherein the second subset of security key bits is mapped to a second resource element of the plurality of resource elements.
Aspect 71: The method of any of Aspects 68-70, wherein the at least one communication comprises a quadrature amplitude modulation (QAM) signal, wherein the first subset of security key bits is appended to the QAM signal.
Aspect 72: The method of any of Aspects 68-71, wherein the at least one communication comprises a quadrature amplitude modulation (QAM) signal, and wherein the QAM signal is phase shift rotated based at least in part on the first subset of security key bits.
Aspect 73: The method of any of Aspects 68-72, wherein the at least one communication comprises a network coded quadrature amplitude modulation (QAM) signal representing an exclusive-OR (XOR) of the first subset of security key bits with a set of data bits.
Aspect 74: The method of any of Aspects 68-73, further comprising encrypting the at least one communication, wherein encrypting the at least one communication comprises mapping the set of security key bits of the security key stream to a plurality of communications of the at least one communication, and wherein mapping the set of security key bits comprises: applying the first subset of security key bits to a first communication of the at least one communication: applying the second subset of security key bits to a second communication of the at least one communication: refreshing the KDF to determine an updated security key stream; and applying a subset of security key bits of a set of security key bits corresponding to the updated security key stream to a third communication of the at least one communication.
Aspect 75: The method of Aspect 74, wherein mapping the set of security key bits comprises mapping the set of security key bits based at least in part on a mapping rule.
Aspect 76: The method of Aspect 75, further comprising transmitting a mapping configuration that indicates the mapping rule.
Aspect 77: An apparatus for wireless communication at a device, comprising a processor: memory coupled with the processor; and instructions stored in the memory and executable by the processor to cause the apparatus to perform the method of one or more of Aspects 1-38.
Aspect 78: A device for wireless communication, comprising a memory and one or more processors coupled to the memory, the one or more processors configured to perform the method of one or more of Aspects 1-38.
Aspect 79: An apparatus for wireless communication, comprising at least one means for performing the method of one or more of Aspects 1-38.
Aspect 80: A non-transitory computer-readable medium storing code for wireless communication, the code comprising instructions executable by a processor to perform the method of one or more of Aspects 1-38.
Aspect 81: A non-transitory computer-readable medium storing a set of instructions for wireless communication, the set of instructions comprising one or more instructions that, when executed by one or more processors of a device, cause the device to perform the method of one or more of Aspects 1-38.
Aspect 82: An apparatus for wireless communication at a device, comprising a processor: memory coupled with the processor; and instructions stored in the memory and executable by the processor to cause the apparatus to perform the method of one or more of Aspects 39-76.
Aspect 83: A device for wireless communication, comprising a memory and one or more processors coupled to the memory, the one or more processors configured to perform the method of one or more of Aspects 39-76.
Aspect 84: An apparatus for wireless communication, comprising at least one means for performing the method of one or more of Aspects 39-76.
Aspect 85: A non-transitory computer-readable medium storing code for wireless communication, the code comprising instructions executable by a processor to perform the method of one or more of Aspects 39-76.
Aspect 86: A non-transitory computer-readable medium storing a set of instructions for wireless communication, the set of instructions comprising one or more instructions that, when executed by one or more processors of a device, cause the device to perform the method of one or more of Aspects 39-76.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a +a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed at a first network node, comprising:
receiving at least one communication of a plurality of communications associated with at least one physical layer channel, wherein a first set of the plurality of communications includes the at least one communication and is secured by a first security key of a plurality of security keys, and wherein a second set of the plurality of communications is secured by a second security key of the plurality of security keys; and
decrypting the at least one communication based at least in part on the first security key, wherein the first security key is based at least in part on a first set of physical layer parameter values, and wherein the second security key is based at least in part on a second set of physical layer parameter values.

2. The method of claim 1, wherein the first set of physical layer parameter values indicates:
a component carrier index,
a bandwidth part value,
a resource pool index associated with a resource pool configured for sidelink operations,
a resource pool parameter value associated with the resource pool,
a time division duplexing (TDD) pattern parameter value,
a frame index,
a slot index,
a sub-slot index,
a slot offset,
a reference signal configuration,
a periodic signaling parameter value associated with a periodic signal configuration,
a resource element frequency index,
a resource element time index, or
any combination thereof.

3. The method of claim 2, wherein the resource pool parameter value indicates at least one of:
a power control parameter value,
a channel busy ratio,
a subcarrier spacing,
a number of configured shared channel symbols,
a number of configured subchannels,
a configured subchannel size, or
a starting subchannel.

4. The method of claim 2, wherein the TDD pattern parameter value indicates at least one of:
a TDD pattern index,
a number of configured downlink symbols,
a number of configured uplink symbols, or
a number of configured flexible symbols.

5. The method of claim 2, wherein the periodic signaling parameter value indicates at least one of:
a semi-persistent scheduling (SPS) index,
a configured grant (CG) index,
an SPS periodicity,
a CG periodicity,
a security key seed associated with the periodic signal configuration, or
an occasion index corresponding to an occasion occurring after a periodic signaling activation time.

6. The method of claim 1, wherein the first security key is based at least in part on a first key configuration having a first set of key configuration parameters, and wherein the second security key is based at least in part on a second key configuration having a second set of key configuration parameters.

7. The method of claim 6, wherein the first key configuration includes a first key derivation function (KDF), the first set of key configuration parameters indicating a first set of KDF inputs corresponding to the first KDF, and wherein the second key configuration includes a second KDF, the second set of key configuration parameters indicating a second set of KDF inputs corresponding to the second KDF.

8. The method of claim 6, wherein the first set of key configuration parameters indicates a first security key refresh time and the second set of key configuration parameters indicates a second security key refresh time.

9. The method of claim 8, wherein the first set of communications corresponds to a first priority level and the second set of communications corresponds to a second priority level, and wherein the first security key refresh time is shorter than the second security key refresh time based at least in part on the first priority level being higher than the second priority level.

10. The method of claim 1, wherein the first set of communications corresponds to a first resource element bundle associated with the first security key and the second set of communications corresponds to a second resource element bundle associated with the second security key, wherein the first resource element bundle corresponds to a first set of allocated resources and the second resource element bundle corresponds to a second set of allocated resources.

11. The method of claim 10, wherein the first set of allocated resources comprises at least one of a first allocated time resource or a first allocated frequency resource, and wherein the second set of allocated resources comprises at least one of a second allocated time resource or a second allocated frequency resource.

12. The method of claim 10, wherein the first resource element bundle corresponds to a first bundle pattern and the second resource element bundle corresponds to a second bundle pattern.

13. The method of claim 12, further comprising receiving a security key pattern configuration that indicates the first bundle pattern and the second bundle pattern.

14. The method of claim 12, wherein a wireless communication standard indicates the first bundle pattern and the second bundle pattern.

15. The method of claim 12, wherein the first bundle pattern and the second bundle pattern are associated with a sidelink resource pool, the method further comprising determining an activated bundle pattern of the first bundle pattern and the second bundle pattern.

16. The method of claim 15, wherein determining the activated bundle pattern comprises receiving an indication of the activated bundle pattern.

17. The method of claim 12, further comprising receiving a bundle configuration that indicates a set of bundle patterns for access link communications, wherein the set of bundle patterns includes the first bundle pattern and the second bundle pattern.

18. The method of claim 10, wherein a first bundle index corresponds to the first resource element bundle and a second bundle index corresponds to the second resource element bundle, wherein the first security key is based at least in part on a first key configuration having a first set of key configuration parameters, and wherein the second security key is based at least in part on a second key configuration having a second set of key configuration parameters, wherein the first key configuration includes a first key derivation function (KDF), wherein a first set of KDF inputs corresponding to the first KDF comprises the first bundle index, and wherein the second key configuration includes a second KDF, wherein a second set of KDF inputs corresponding to the second KDF comprises the second bundle index.

19. The method of claim 1, wherein the first security key comprises a first subset of security key bits of a set of security key bits corresponding to a security key bit stream based at least in part on a key derivation function (KDF), and wherein the second security key comprises a second subset of security key bits of the set of security key bits, wherein a number of security key bits in the first subset of security key bits is based at least in part on a modulation order.

20. The method of claim 19, wherein the first subset of security key bits is mapped to a first resource element of a plurality of resource elements, and wherein the second subset of security key bits is mapped to a second resource element of the plurality of resource elements.

21. The method of claim 19, wherein the at least one communication comprises a quadrature amplitude modulation (QAM) signal, wherein the first subset of security key bits is appended to the QAM signal.

22. The method of claim 19, wherein the at least one communication comprises a quadrature amplitude modulation (QAM) signal, and wherein the QAM signal is phase shift rotated based at least in part on the first subset of security key bits.

23. The method of claim 19, wherein the at least one communication comprises a network coded quadrature amplitude modulation (QAM) signal representing an exclusive-OR (XOR) of the first subset of security key bits with a set of data bits.

24. The method of claim 19, wherein decrypting the at least one communication comprises mapping the set of security key bits of the security key stream to a plurality of communications of the at least one communication, and wherein mapping the set of security key bits comprises:
applying the first subset of security key bits to a first communication of the at least one communication:
applying the second subset of security key bits to a second communication of the at least one communication:
refreshing the KDF to determine an updated security key stream; and
applying a subset of security key bits of a set of security key bits corresponding to the updated security key stream to a third communication of the at least one communication.

25. A method of wireless communication performed at a second network node, comprising:
transmitting a first communication of a plurality of communications associated with at least one physical layer channel, wherein a first set of the plurality of communications includes the first communication and is secured by a first security key of a plurality of security keys; and
transmitting a second communication of the plurality of communications, wherein a second set of the plurality of communications is secured by a second security key of the plurality of security keys.

26. The method of claim 25, wherein the first set of physical layer parameter values indicates:
a component carrier index,
a bandwidth part value,
a resource pool index associated with a resource pool configured for sidelink operations,
a resource pool parameter value associated with the resource pool,
a time division duplexing (TDD) pattern parameter value,
a frame index,
a slot index,
a sub-slot index,
a slot offset,
a reference signal configuration,
a periodic signaling parameter value associated with a periodic signal configuration,
a resource element frequency index,
a resource element time index, or
any combination thereof.

27. A first network node for wireless communication, comprising:
a memory; and
one or more processors, coupled to the memory, configured to:
receive at least one communication of a plurality of communications associated with at least one physical layer channel, wherein a first set of the plurality of communications includes the at least one communication and is secured by a first security key of a plurality of security keys, and wherein a second set of the plurality of communications is secured by a second security key of the plurality of security keys; and
decrypt the at least one communication based at least in part on the first security key, wherein the first security key is based at least in part on a first set of physical layer parameter values, and wherein the second security key is based at least in part on a second set of physical layer parameter values.

28. The first network node of claim 27, wherein the first set of physical layer parameter values indicates:
a component carrier index,
a bandwidth part value,
a resource pool index associated with a resource pool configured for sidelink operations,
a resource pool parameter value associated with the resource pool,
a time division duplexing (TDD) pattern parameter value,
a frame index,
a slot index,
a sub-slot index,
a slot offset,
a reference signal configuration,
a periodic signaling parameter value associated with a periodic signal configuration,
a resource element frequency index,
a resource element time index, or
any combination thereof.

29. A first network node for wireless communication, comprising:
a memory; and
one or more processors, coupled to the memory, configured to:
transmit a first communication of a plurality of communications associated with at least one physical layer channel, wherein a first set of the plurality of communications includes the first communication and is secured by a first security key of a plurality of security keys; and
transmit a second communication of the plurality of communications, wherein a second set of the plurality of communications is secured by a second security key of the plurality of security keys.

30. The first network node of claim 29, wherein the first set of physical layer parameter values indicates:
a component carrier index,
a bandwidth part value,
a resource pool index associated with a resource pool configured for sidelink operations,
a resource pool parameter value associated with the resource pool,
a time division duplexing (TDD) pattern parameter value,
a frame index,
a slot index,
a sub-slot index,
a slot offset,
a reference signal configuration,
a periodic signaling parameter value associated with a periodic signal configuration,
a resource element frequency index,
a resource element time index, or
any combination thereof.
